(19) United States
(12) Patent Application Publication
(10) Pub. No.: US 2026/0167007 A1
(43) Pub. Date: Jun. 18, 2026

(54) GUIDANCE SYSTEM FOR ALIGNMENT WITH A POWER SOURCE

(71) Applicant: Caterpillar Global Mining Equipment LLC, Denison, TX (US)

(72) Inventors: Thomas Ryan Cassity, Morton, IL (US); Andrew John Olson, Vail, AZ (US); Nitin R Patel, Tucson, AZ (US); Igor Strashny, Tucson, AZ (US); Benjamin Devers Kaufman, Tucson, AZ (US)

(73) Assignee: Caterpillar Global Mining Equipment LLC, Denison, TX (US)

(21) Appl. No.: 18/980,988

(22) Filed: Dec. 13, 2024

(51) Int. Cl. B60L 5/38; B60L 53/37

(52) U.S. Cl. CPC B60L 5/38; B60L 53/37; B60L 2200/40

(57) ABSTRACT

A guidance system to assist in alignment between an electric machine and power rails from which the electric machine draws electrical power is disclosed. The power may be drawn by the electric machine from the power rails via an arm having a rotating joint and a rotation sensor that measures the level of rotation of the rotating joint. A controller may receive signals indicative of the rotation angle of the rotating joint and indicate, on a display, the direction and/or magnitude of misalignment between the electric machine and the power rails. The operator of the electric machine can observe the indication of misalignment and use that information to steer the electric machine to the left or the right to better align the electric machine to the power rails. The indication of misalignment may be overlayed on a real-time video display of a path in front of the electric machine.

### TECHNICAL FIELD

The present disclosure relates to providing power to a machine powered by electricity. More specifically, the present disclosure relates to providing guidance to an operator for maintaining alignment between the machine and a power source.

### BACKGROUND

Machines, such as mining trucks, loaders, dozers, compaction machines, or other construction or mining equipment, are often powered by any variety of fuel (e.g., diesel, gasoline, etc.). Recently, there is interest in powering machines using electricity. These electric machines are used for building, construction, mining and other activities, such as at a worksite. For example, mining trucks are often used for hauling mined materials from mining sites. It is desirable to have a high uptime for these machines. As a result, a worksite, such as a mining site, may have a power system to which electric machines may connect to power themselves and/or to charge their batteries. Such an arrangement has several advantages, including relatively high uptime of electric machines due to the electric machines not having to charge for long times at static charging stations. Additionally, such site arrangements may enable each of the electric machines to have smaller on-board batteries, since the electric machines are able to operate and charge themselves while carrying out worksite tasks. This results in reduced weight of the electric machines, reduced cost of the electric machines, and/or improved reliability of the electric machines.

While sitewide power systems with electric machines that can be powered by such power systems present various advantages, such as environmental advantages, cost advantages, and productivity advantages, such a system may require the machine to be aligned with the power system to receive power. In other words, if an electric machine is not properly situated relative to current carrying elements of the power system, the machine may not receive power from the power system. Misalignment between the machine's power collecting apparatus and the current carrying elements of the power system, can therefore, lead to the machine being unable to recharge its batteries from the power system deployed at the worksite. It is therefore desirable to improve the alignment between machines and the power systems from which they derive power. Additionally, it is desirable to not distract the operator of the machine during the process of maintaining a near constant distance between the machine and the power system.

One mechanism for operating a dump truck drawing power from an overhead pantograph system is described in U.S. Pat. No. 10,919,395 (hereinafter referred to as “the '395 reference”). The '395 reference describes a mechanism by which a pantograph system providing power to dump trucks can be moved up or down to accommodate different heights of different dump trucks traversing under the pantograph system. However, the systems and methods described in the '395 reference does not pertain to a power system on the side of the electric machine and lateral alignment therewith. Thus, the disclosure of the '395 reference does not describe how to operate electric machines at a worksite to assist an operator with maintaining alignment with the worksite power systems.

Examples of the present disclosure are directed toward overcoming one or more of the deficiencies noted above.

### SUMMARY

In an aspect of the present disclosure, An alignment guidance system includes a rotation sensor associated with a power collecting arm of an electric machine, the power collecting arm configured to collect power from a power rail, a controller including one or more processors, an indicator, and one or more computer-readable media storing computer-executable instructions. When the computer-executable instructions are executed by the one or more processors, the controller receives a signal from the rotation sensor, the signal indicative of a level of rotation of the power collecting arm, determines, based at least in part on the signal, a first distance between the electric machine and the power rail, and displays, on the indicator, an indication of the first distance between the electric machine and the power rail.

In another aspect of the present disclosure, a method includes receiving, by a controller comprising one or more processors, a signal from a rotation sensor associated with an arm of an electric machine for collecting current from a power rail, the signal indicative of a level of rotation of the arm. The method further includes determining, based at least in part on the signal, an angle of rotation of the arm, displaying, on an indicator using one or more lights, an indication of the angle of rotation of the arm, and displaying, on the indicator, a direction that the electric machine is to be steered to reduce the rotation of the arm from a baseline rotation angle.

In yet another aspect of the present disclosure, an electric machine includes a power collecting arm to collect power from a power rail, a rotation sensor associated with the power collecting arm, an indicator, and a controller. The controller is configured to receive a signal from the rotation sensor, the signal indicative of a level of rotation of the power collecting arm, determine, based at least in part on the signal, an angle of rotation of the power collecting arm, and display, on the indicator using one or more lights, an indication of the angle of rotation of the power collecting arm.

### BRIEF DESCRIPTION OF DRAWINGS

FIG. 1 is a schematic illustration of an example environment with an electric machine, in accordance with examples of the disclosure.

FIG. 2 is a schematic illustration of the arm depicted in FIG. 1, according to examples of the disclosure.

FIG. 3 is a schematic illustration of an environment with an alignment indicator indicating alignment between the electric machine and the power system, according to examples of the disclosure.

FIG. 4 is a schematic illustration of an example display indicating alignment between the electric machine and the power system, according to examples of the disclosure.

FIG. 5 is a flow diagram depicting an example method for indicating an alignment of the electric machine with the power rails of the power system that delivers power to the electric machine, according to examples of the disclosure.

FIG. 6 is a schematic illustration of a range of angles of misalignment accommodated by the arm of the electric machine during operation, according to examples of the disclosure.

FIG. 7 is a block diagram of an example controller that may assist in alignment of the electric machine with the power system, according to examples of the disclosure.

### DETAILED DESCRIPTION

Wherever possible, the same reference numbers will be used throughout the drawings to refer to the same or like parts.

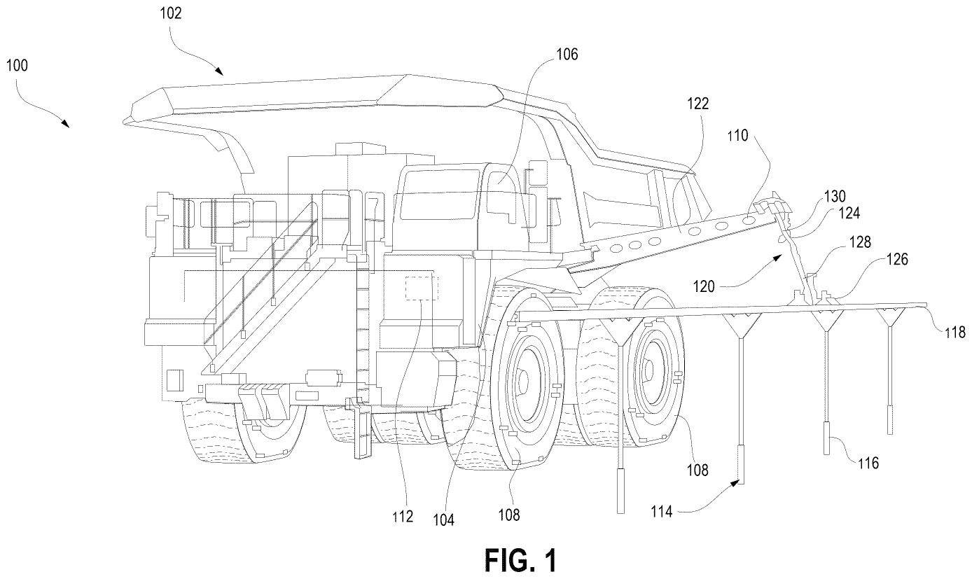

FIG. 1 is a schematic illustration of an example environment 100 with an electric machine 102, in accordance with examples of the disclosure. The electric machine 102, as depicted may travel on ground, such as along paths on the worksite environment 100. The electric machine 102 includes a frame 104, an operator station 106, and wheels 108. The frame 104 of the electric machine 102 is constructed from any suitable materials, such as iron, steel, aluminum, other metals, ceramics, plastics, the combination thereof, or the like. The wheels 108 are mechanically coupled to a drive train (not shown) to propel the electric machine 102. When the wheels 108 of the electric machine 102 are caused to rotate, the electric machine 102 traverses the ground. Although illustrated as having a hub with a rubber tire, in other examples, the wheels 108 may instead be in the form of drums, chain drives, combinations thereof, or the like.

The electric machine 102 may be driven by electrical power, and therefore includes motors (not shown) that are electrically powered by a battery pack or battery, with a battery controller. The motors of the electric machine 102 may be of any suitable type, such as induction motors, permanent magnet motors, switched reluctance (SR) motors, combinations thereof, or the like. The motors are of any suitable voltage, current, and/or power rating. The motors, when operating, are configured to propel the electric machine 102 as needed for tasks that are to be performed by the electric machine 102. The electric machine 102 may also include a regenerative braking system, which allows the electric machine 102 to recapture some of its kinetic energy while braking, which would otherwise be wasted.

The electric machine 102, although depicted as a mining truck type of machine, may be any suitable machine, such as any type of loader, dozer, dump truck, skid loader, excavator, compaction machine, backhoe, combine, crane, drilling equipment, tank, trencher, tractor, any suitable stationary machine, any variety of generator, locomotive, marine engines, combinations thereof, or the like. The electric machine 102 is configured for propulsion using electricity, as received from an external power source and/or stored in on-board batteries. The electric machine 102 is illustrated as a mining truck, which is used, for example, for moving mined materials, heavy construction materials, and/or equipment, and/or for road construction, building construction, other mining, paving and/or construction applications. For example, the electric machine 102 is used in situations where materials, such as mineral ores, loose stone, gravel, soil, sand, concrete, and/or other materials of the worksite environment 100 need to be transported. As discussed herein, the electric machine 102 may also be in the form of a dozer, where the electric machine 102 is used to redistribute and/or move material on the surface. Further still, the electric machine 102 may be in the form of a compaction machine that can traverse the surface and impart vibrational forces to compact the surface. Such a compaction machine includes drums, which may vibrate to impart energy to the surface for compaction. For example, an electric machine 102 is configured to compact freshly deposited asphalt and/or other materials disposed on and/or associated with the ground, such as to build a road or parking lot. It should be understood that the electric machine 102 can be in the form of any other type of suitable construction, mining, farming, military, and/or transportation machine. In the interest of brevity, without individually discussing every type of construction and/or mining machine, it should be understood that the electric power delivery and alignment mechanisms, as described herein, are configured for use in a wide variety of electric machines 102.

The operator station 106 is configured to seat an operator (not shown) therein. The operator seated in the operator station 106 interacts with various control interfaces and/or actuators within the operator station 106 to control movement of various components of the electric machine 102 and/or the overall movement of the electric machine 102 itself. Thus, control interfaces and/or actuators within the operator station 106 allow the control of the propulsion of the electric machine 102 by controlling operation of one or more motors and/or the direction of travel. For example, the operator seated in the operator station 106 may be able to steer the electric machine 102 to the left or to the right by varying degrees. In some cases, the operator may be able to change the direction of the electric machine 102 to maintain the collection of electric power by the electric machine 102.

The electric machine 102 may include one or more camera(s) 110, which may be oriented towards the path to be traversed by the electric machine 102. The camera may be of any suitable type (e.g., charge coupled device, etc.) and collect digital images in any suitable format and/or frame rate to display to the operator, such as an operator within the operator station 106 and/or a remote operator. The camera 110 may be configured to capture images and/or video of the path and/or road on which the electric machine 102 travels. The camera may be disposed on a boom 122 or any other suitable location of the electric machine 100.

The electric machine 102 includes a controller 112 that controls various aspects of the electric machine 102. The controller 112 is configured to receive battery status (e.g., state-of-charge (SOC) or other charge related metrics) from a battery and/or battery controller, operator signal(s), such as an accelerator signal, based at least in part on the operator's interactions with one or more control interfaces and/or actuators of the electric machine 102. In other cases, the controller 112 may receive control signals from a remote control system by wireless signals and execute autonomous operations of the electric machine 102. The controller 112 uses the operator signal(s), regardless of whether they are received from an operator in the operator station 106 or from a remote station, to generate command signals to control various components of the electric machine 102. It should be understood that the controller 112 may control any variety of subsystems of the electric machine 102 that are not explicitly discussed here to provide the electric machine 102 with the operational capability discussed herein.

The controller 112 includes single or multiple microprocessors, field programmable gate arrays (FPGAs), digital signal processors (DSPs), and/or other components configured to control the electric machine 102. Numerous commercially available microprocessors can be configured to perform the functions of the controller 112. Various known circuits are operably connected to and/or otherwise associated with the controller 112 and/or the other circuitry of the electric machine 102. Such circuits and/or circuit components include power supply circuitry, inverter circuitry, signal-conditioning circuitry, actuator driver circuitry, etc. The present disclosure, in any manner, is not restricted to the type of controller 112 or the positioning depicted of the controller 112 and/or the other components relative to the electric machine 102. The controller 112 is configured to provide feedback to an operator of the electric machine's position for optimally receiving power.

The environment 100 may include a power system 114 from which the electric machine 102 may receive power. The power system 114 may include multiple stands 116 holding power rails 118. As shown, the stands 116 may hold the power rails 118 on one side of the electric machine 102, such as along a length of road or pathway on which the electric machine 102 is to travel. The power rails 118 may be configured to provide to the electric machine 102 with any suitable type and/or magnitude of electrical power. In some cases, the power rails 118 may provide alternating current (AC) power at any suitable frequency, voltage and current. In other cases, the power rails 118 may provide direct current (DC) power at any suitable voltage and current. In one non-limiting example, the power rails 118 may provide +1500 VDC and −1500 VDC to the electric machine 102. These values are merely examples, and other electrical configurations for the power rails 118 are available within the knowledge of those of ordinary skill in the art.

The electric machine 102 further includes an arm 120 attached to a boom 122 for collecting electrical power from the power rails 118 of the power system 114. The boom 122 may be attached on one end to the electric machine 102 and attached to the arm 120 on the opposing end. The electric current as received from the power rails 118 may be conducted through the arm 120 and the boom 122 to power the various components of the electric machine 102, including its propulsion motors. The power received from the power rails 118 via the arm 120 may also be stored on-board, such as in a battery, for use later, such as when the electric machine 102 is not electrically and/or mechanically connected to the power system 114 and its power rails 118.

The arm 120 may include various components that enable the electric machine 102 and the power system 114 and its power rails 118 to not be perfectly aligned and still draw power. In other words, the arm 120 has the ability to enable variations in distance between the electric machine 102 and the power rails 118, while still allowing the electric machine 102 to receive power from the power rails 118. The arm 120 may include an upper extension 124, a current collector 126, a lower extension 128, and a rotating joint 130. The upper extension 124 may be mechanically coupled, such as in a rotatable fashion, with the boom 122. The rotating joint 130 may provide rotational movement between the arm 120 and the power rails 118, which allows for current collection even when the electric machine 102 and the power system 114 are not perfectly spaced. The lower extension 128 may be mechanically coupled, such as in a rotatable fashion, with the current collector 126. The current collector 126, when deployed and operational, may make physical contact with the power rails 118 of the power system 114. The current collector 126 may receive electrical current from the power rails 118 and conduct that current via conductors (e.g., wires, cables, etc.) held by the lower extension 128, upper extension 124, and the boom 122, to the electric machine 102.

The rotating joint 130 allows for movement in a rotating fashion, such that the arm 120 can precede or lag the boom 122. By allowing the rotating freedom by way of the rotating joint 130, some misalignments between the electric machine 102 and the power system 114 may be accounted for by the rotation of the rotating joint 130. In other words, if the electric machine 102 is too close or too far from the power rails 118, the rotating joint 130 may rotate from a baseline angle between the arm 120 and the boom 122. For example, the arm 120 may be configured to deflect by up to a predetermined angle to allow for imperfect maintenance of distance between the electric machine 102 and the power rails 118 of the power system 114 as the electric machine 102 travels.

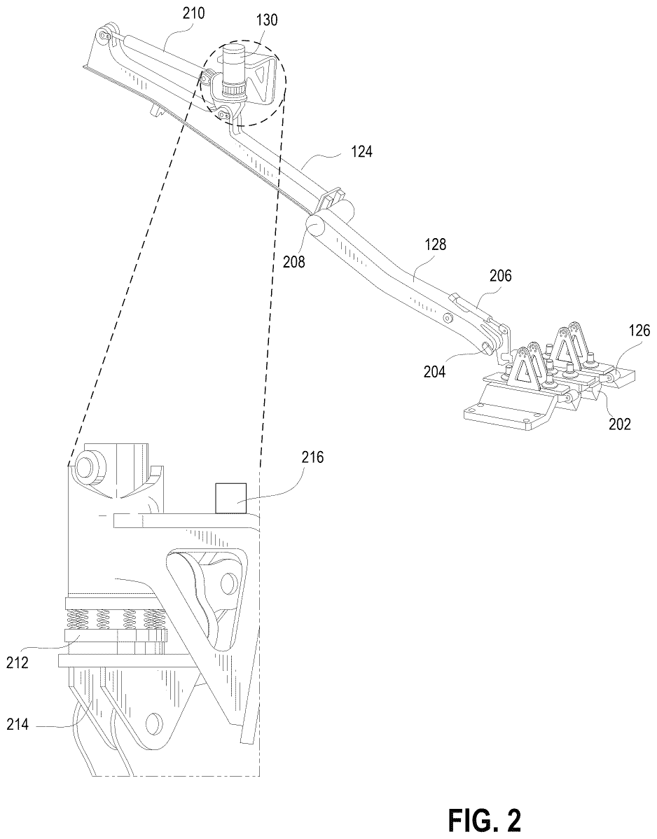

The controller 112, according to examples of this disclosure, may be configured to indicate the level of alignment between the arm 120 and the power rails 118 of the power system 114. Ideally, the arm 120 would not be deflected at all (0° deflection from baseline) while collecting power from the power rails 118. Although the arm 120, by deflecting from its baseline angle, can accommodate some misalignment between the arm 120 and the power rails 118, there is a limit to the level of misalignment that can be tolerated, as related to the distance between the electric machine 102 and the power rails 118. The controller 112 is configured to determine a level of deflection or rotation of the arm 120 from a baseline level, such as by receiving signal(s) from a rotation sensor disposed on the arm 120 and discussed further in conjunction with FIG. 2.

The controller 112, according to examples of the disclosure, may be configured to receive signals from a rotation sensor and determine, based at least in part on the signals, a level of rotation of the arm 120 relative to a baseline level. The level of rotation in the arm 120 may be translated, by the controller 112, to a distance between the electric machine 102 and the power rails 118. That level of distance may be displayed to an operator, such as an operator seated in the operator station 106 and/or to a remote operator, who remotely controls the electric machine 102.

The display of the distance, such as via any variety of human machine interface(s) (HMIs), may be displayed to the operator. This allows the operator to understand whether the electric machine 102 ought to be steered left or right to improve the alignment between the electric machine 102 and the power rails 118. In some cases, the display of misalignment between the arm 120 and the power rail 118 may be displayed in a manner that is intended to minimize distraction of the operator of the electric machine 102. For example, the HMIs used to display how the operator may improve the distance of the electric machine 102 to the power rails 118 may be displayed on a light strip outside of the operator station 106, on a video feed screen showing the forward path being traversed by the electric machine 102 with an overlay of the alignment and/or distance, a heads-up display, or any other low-distraction display mechanism.

It should be appreciated that electric machines 102 described herein may be large, heavy-duty machines that have limited range due to high amounts of energy required to power them, versus the limited space and weight available to store on-board batteries. As a result, the power system 114, as deployed at a worksite to transfer energy to the electric machines 102 while the electric machines 102 perform their allocated tasks provides power to both run the electric machine 102 and charge the batteries and provides for a more optimized on-board energy storage. However, smaller batteries on the electric machine 102 may pose a risk if the availability and collection of power from the power system 114 by the electric machine 102 is not reliable or robust. Misalignment of the electric machine 102 and the power rails 118 (e.g., relatively excessive excursions in the distance between the electric machine 102 and the power rails 118) can prevent the transference of power from the power rails 118 to the electric machine 102 or even damage the power rails 118 and/or the electric machine 102. The systems and methods, as disclosed herein, allows an operator to more tightly control the distance between the electric machine 102 and power rails 118 to reduce the probability and/or severity of excursions in the distance, thus providing for a more reliable power transfer process.

FIG. 2 is a schematic illustration of the arm 120 depicted in FIG. 1, according to examples of the disclosure. As shown, the current collector 126 may include ridges 202 that allow the current collector 126 to be properly seated on the power rails 118. For example, individual power rails 118, carrying current, may pass between each of the ridges 202 of the current collector 126, while electrodes of the current collector 126 collect the power supplied by the power rails 118. The current collector 126 may be connected to the lower extension 128 via a joint 204 that may allow movement between the current collector 126 and the lower extension 128, such as movement in one, two, or three degrees of freedom. A hydraulic element 206 may provide tension (e.g., mechanical/spring bias) to the joint 204. The upper extension 124 and the lower extension 128 may be connected by way of joint 208. Like joint 204, joint 208 may allow relative movement of the upper extension 124 and the lower extension 128. The arm 120 may further include a hydraulic element 210 that may allow relative movement of the arm 120 relative to the boom 122 of the electric machine 102.

The rotating joint 130, as discussed in conjunction with FIG. 1, allows the arm 120 to deflect from a baseline angle between the arm 120 and the power rails 118 of the power system 114. It is this deflection of the arm from a baseline angle that allows for misalignment between the arm 120 and the power rails 118. It is also this window of allowed misalignment between the arm 120 and the power rails 118 that provides for a window of excursion from a baseline distance between the electric machine 102 and the power rails 118 from which it draws power.

The rotating joint 130 may include a rotating element 212, a mount 214, and a rotation sensor 216. The mount 214 may be used to connect the rotating joint 130 to the arm 120. The rotating element 212 allows the arm 120 to deflect within an angular range (e.g., +/−25°, +/−35°, etc.) from a baseline angle between the arm 120 and the power rails 118. The rotating element 212 may include a number of springs and/or other mechanical bias devices to provide some resistance to the rotation of the arm 120 to the power rails 118.

The rotation sensor 216 may be of any suitable type, such as any sensor that provides a signal representative and/or indicative of a level of rotation of the rotating joint 130 and/or the rotating element 212. The rotational sensor 216 may be a rotary potentiometer sensor, a magnetic sensor, a rotational variable differential transformer (RVDT) sensor, Hall rotational sensor, piezoelectric or other tribological sensor, combinations thereof or the like. Regardless of the type of rotational sensor 216, the rotational sensor may provide a time-series signal indicative of a level of rotation of the arm 120 and/or rotating joint 130 to the controller 112. The controller 112 may receive the signal(s), such as time-series signals, from the rotation sensor 216 to generate a human-perceptible indication of the distance from the baseline/ideal distance between the electric machine 102 and the power rails 118. Similarly, the controller 112 may receive the signal(s), such as time-series signals, from the rotation sensor 216 to generate a human-perceptible indication of the angular deflection from the baseline/ideal angle between the arm 120 and the power rails 118. An operator of the electric machine 102 may use the indication of the distance and/or angle to steer the electric machine 102 to enhance the robustness of the power delivery from the power system 114 and the electric machine 102.

It will be appreciated that the electric machine 102 is optimized to have smaller on-board batteries due to the systems and methods as discussed herein, resulting in lower costs, improved reliability, and/or improved performance. At the same time, the electric machines 102, as well as the overall worksite 100 is more robust to the ill effects of misalignment of the arm 120 and the power system 114, in accordance with the disclosure herein.

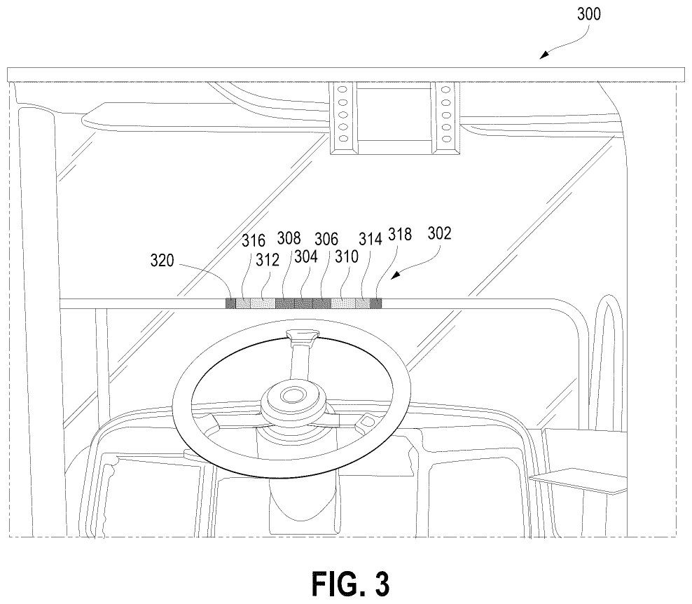

FIG. 3 is a schematic illustration of an environment 300 with an alignment indicator 302 indicating alignment between the electric machine 102 and the power system 114, according to examples of the disclosure. As shown, the indicator is disposed on a rod on the exterior of the electric machine 102. This is a good location because this is in the line of sight of an operator sitting in the operator station 106 of the electric machine 102, steering the electric machine 102. Thus, the operator can continue looking out the windshield of the electric machine 102, looking at the path being traveled by the electric machine 102 and the still be able to view the indicator 302. In other words, the operator can look at the indicator 302 without distraction or without looking away from the path being traversed by the electric machine 102. Other forms of the indicator 302, such as a heads-up display, a projection on a windshield, an audio indicator, a tactile (e.g., vibrational) indicator, or the like may also assist the operator without distracting them from the role of operating the electric machine 102.

The indicator 302 may include a variety of colors to indicate whether the electric machine 102 is spaced at or close to the optimal and/or baseline spacing between the electric machine 102 and the power rails 118. As shown, a green light 304 may indicate a relatively great and/or near optimal spacing between the electric machine 102 and the power rails 118. Green light 306 may indicate relatively good spacing that is slightly to the right of the optimal spacing. Green light 308 may indicate relatively good spacing that is slightly to the left of the optimal spacing. Yellow light 310 may indicate relatively fair spacing that is moderately to the right of the optimal spacing. Yellow light 312 may indicate relatively fair spacing that is moderately to the left of the optimal spacing. Orange light 314 may indicate relatively poor spacing, yet electrically connected between the electric machine 102 and the power rails 118, that is to the right of the optimal spacing. Orange light 316 may indicate relatively poor spacing, yet electrically connected between the electric machine 102 and the power rails 118, that is slightly to the left of the optimal spacing. Red light 318 may indicate poor spacing, where the electric machine 102 and the power rails 118 are disconnected, that is to the right of the optimal spacing. Red light 320 may indicate poor spacing, where the electric machine 102 and the power rails 118 are disconnected, that is to the left of the optimal spacing.

It should be understood that the various lights of the indicator 302 may provide guidance to an operator of the electric machine 102, such as an operator seated in the operator station 106 or a remote operator. For example, the green light 304 may indicate that no adjustments are needed to better align the electric machine 102 to the power rails 118. The green light 306 may indicate that steering the electric machine 102 slightly to the left (from the perspective of the operator in the operator station) would improve the distance between the electric machine 102 and the power rails 118 to be closer to an optimal and/or baseline distance. The green light 308 may indicate that steering the electric machine 102 slightly to the right (from the perspective of the operator in the operator station) would improve the distance between the electric machine 102 and the power rails 118 to be closer to an optimal and/or baseline distance. The yellow light 310 may indicate that steering the electric machine 102 moderately to the left (from the perspective of the operator in the operator station) would improve the distance between the electric machine 102 and the power rails 118 to be closer to an optimal and/or baseline distance.

The yellow light 312 may indicate that steering the electric machine 102 moderately to the right (from the perspective of the operator in the operator station) would improve the distance between the electric machine 102 and the power rails 118 to be closer to an optimal and/or baseline distance. The orange light 314 may indicate that steering the electric machine 102 more significantly to the left (from the perspective of the operator in the operator station) would improve the distance between the electric machine 102 and the power rails 118 to be closer to an optimal and/or baseline distance. The orange light 316 may indicate that steering the electric machine 102 more significantly to the right (from the perspective of the operator in the operator station) would improve the distance between the electric machine 102 and the power rails 118 to be closer to an optimal and/or baseline distance. The red light 318 may indicate that steering the electric machine 102 significantly to the left (from the perspective of the operator in the operator station) would improve the distance between the electric machine 102 and the power rails 118 to be closer to an optimal and/or baseline distance or that the current collector 126 needs to be reconnected with the power rails 118. The red light 320 may indicate that steering the electric machine 102 significantly to the right (from the perspective of the operator in the operator station) would improve the distance between the electric machine 102 and the power rails 118 to be closer to an optimal and/or baseline distance or that the current collector 126 needs to be reconnected with the power rails 118.

It should still further be understood that the various lights of the indicator 302 may indicate if the distance between the electric machine 102 and the power rails 118 of the power system 114 is too great (e.g., greater than an optimal and/or baseline distance) or too little (e.g., less than an optimal and/or baseline distance) to an operator, such as an operator seated in the operator station 106 or a remote operator. For example, the green light 304 may indicate that no adjustments are needed to improve the electric machine 102 to the power rails 118, as the electric machine 102 to the power rails 118 distance is reasonably close to the optimal and/or baseline distance. However, if the boom 122 and arm 120 are on the left side of the electric machine 102 from the perspective of an operator seated in the operator station 106, as depicted in FIG. 1, the green light 306 may indicate that the distance between the electric machine 102 and the power rails 118 are slightly farther than an optimal and/or baseline distance. Similarly, with the boom 122 and arm 120 on the left side of the electric machine 102 from the perspective of an operator seated in the operator station 106, the green light 308 may indicate that the distance between the electric machine 102 and the power rails 118 is slightly closer than an optimal and/or baseline distance. The yellow light 310, with the boom 122 and arm 120 on the left side of the electric machine 102, may indicate that the distance between the electric machine 102 and the power rails 118 is moderately farther than an optimal and/or baseline distance.

The yellow light 312, with the boom 122 and arm 120 on the left side of the electric machine 102, may indicate that the distance between the electric machine 102 and the power rails 118 is moderately closer than an optimal and/or baseline distance. The orange light 314, with the boom 122 and arm 120 on the left side of the electric machine 102, may indicate that the distance between the electric machine 102 and the power rails 118 is more significantly farther than an optimal and/or baseline distance. The orange light 316, with the boom 122 and arm 120 on the left side of the electric machine 102, may indicate that the distance between the electric machine 102 and the power rails 118 is more significantly closer than an optimal and/or baseline distance. The red light 318, with the boom 122 and arm 120 on the left side of the electric machine 102, may indicate that the distance between the electric machine 102 and the power rails 118 is significantly farther than an optimal and/or baseline distance and may indicate that the electric machine 102 and the power rails 118 are disconnected and the electric machine may not be receiving power from the power rails 118. The red light 320, with the boom 122 and arm 120 on the left side of the electric machine 102, may indicate that the distance between the electric machine 102 and the power rails 118 is significantly closer than an optimal and/or baseline distance and may indicate that the electric machine 102 and the power rails 118 are disconnected and the electric machine may not be receiving power from the power rails 118. It will be appreciated that if the boom 122 and the arm 120 were on the other side (e.g., on the right side of the electric machine 102 from the perspective of an operator seated in the operator station 106, then the distances relative to the optimal distance and/or baseline distance would be the opposite of what is described above. Regardless of whether the electric machine 100 is closer or farther than an optimal distance from the power rails 118, the distance between the two can be improved (e.g., brought closer to the optimal and/or baseline distance between the two) by steering the electric machine 100 to one side or the other.

It should be understood that the color scheme and the meaning of each light is an example, and that the disclosure contemplates the use of different number of lights, different color of lights, and/or different mappings of light to severity of misalignment. Thus, the indicator 302, as disclosed herein, ought not be seen as limiting, but rather as one example of a low-distraction alignment guide for an operator of the electric machine 102 to improve the robustness of power transfer and/or reduce faults or disconnections between the electric machine 102 and the power rails 118.

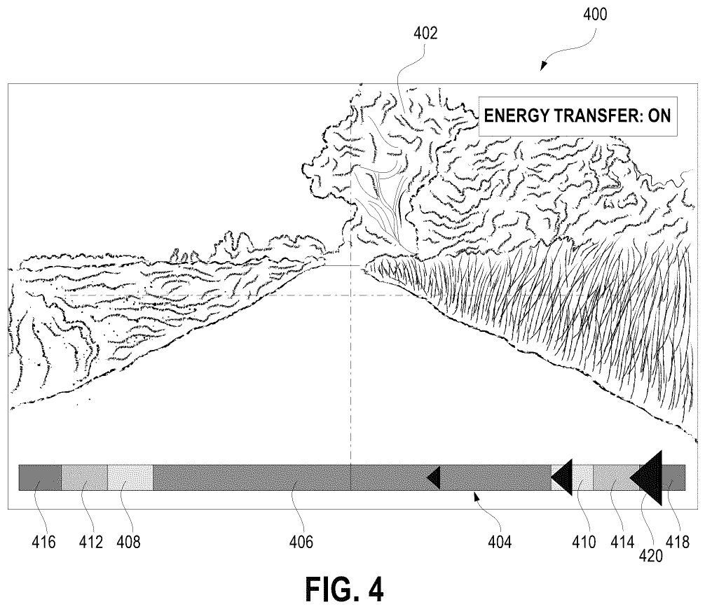

FIG. 4 is a schematic illustration of an example display 400 indicating alignment between the electric machine 102 and the power system 114, according to examples of the disclosure. The display 400 may use a similar or different color scheme as indicator 302 of FIG. 3 to indicate the level of misalignment of the arm 120 with the power rails 118 of the power system 114. The display 400 may be generated by the controller 112 using signals received from the camera 110 and signals received from the rotation sensor 216. The display 400 may be shown on any suitable screen configured to display a video feed, such as any suitable screen within the operator station 106 and/or any suitable screen at a remote operation station where a remote operator may be controlling the electric machine 102.

The display 400 may show an image 402 of the path being traversed by the electric machine 102, as well as an overlayed indicator 404 of the alignment between the arm 120 and the power rails 118 and/or the distance between the electric machine 102 and the power rails 118. In this way, the operator of the electric machine 102 can be informed of the level of misalignment associated with the power system 114 without being distracted from viewing the road in front of them.

As stated herein, the color coding of indicator 404 may be similar to the color coding of indicator 302. Green light 406 may light up to indicate a relatively good alignment between the arm 120 and the power rails 118, as compared to a baseline angle between the arm 120 and the power rails 118. Yellow lights 408, 410 may light up to indicate a relatively fair alignment between the arm 120 and the power rails 118, as compared to a baseline angle between the arm 120 and the power rails 118. Orange lights 412, 414 may light up to indicate a relatively moderate alignment between the arm 120 and the power rails 118, as compared to a baseline angle between the arm 120 and the power rails 118. Red lights 416, 418 may light up to indicate a relatively poor alignment between the arm 120 and the power rails 118, as compared to a baseline angle between the arm 120 and the power rails 118, or even a disconnection between the current collector 126 and the power rails 118.

The color guide of the indicator 404 may also be indicative of the distance between the electric machine 102 and the power rails 118, as compared to an ideal or baseline distance between the two. For example, the green light 406 being illuminated may indicate that the distance between the electric machine 102 and the power rails 118 is pretty close to the ideal and/or baseline distance. The yellow light 408 being illuminated may indicate that the distance between the electric machine 102 and the power rails 118 is reasonably close to the ideal and/or baseline distance, but slightly to the left. Therefore, if the operator of the electric machine 102 were to steer the electric machine 102 slightly to the right, then the distance between the electric machine 102 and the power rails 118 would be closer to the ideal and/or baseline distance. The yellow light 410 being illuminated may indicate that the distance between the electric machine 102 and the power rails 118 is reasonably close to the ideal and/or baseline distance, but slightly to the right. Therefore, if the operator of the electric machine 102 were to steer the electric machine 102 slightly to the left, then the distance between the electric machine 102 and the power rails 118 would be closer to the ideal and/or baseline distance.

The orange light 412 being illuminated may indicate that the distance between the electric machine 102 and the power rails 118 is migrating away from the ideal and/or baseline distance, but moderately to the left. Therefore, if the operator of the electric machine 102 were to steer the electric machine 102 moderately to the right, then the distance between the electric machine 102 and the power rails 118 would be closer to the ideal and/or baseline distance. The orange light 414 being illuminated may indicate that the distance between the electric machine 102 and the power rails 118 is migrating away from an ideal and/or baseline distance, but moderately to the right. Therefore, if the operator of the electric machine 102 were to steer the electric machine 102 moderately to the left, then the distance between the electric machine 102 and the power rails 118 would be closer to the ideal and/or baseline distance.

The red light 416 being illuminated may indicate that the distance between the electric machine 102 and the power rails 118 is not close to the ideal and/or baseline distance, or even disconnected, and to the left. Therefore, if the operator of the electric machine 102 were to steer the electric machine 102 significantly to the right, then the distance between the electric machine 102 and the power rails 118 would be closer to the ideal and/or baseline distance. In some cases, extra procedures may be needed to reconnect the current collector 126 of the arm 120 with the power rails 118 of the power system 114. The red light 418 being illuminated may indicate that the distance between the electric machine 102 and the power rails 118 is not close to an ideal and/or baseline distance, or even disconnected, and to the right. Therefore, if the operator of the electric machine 102 were to steer the electric machine 102 significantly to the left, then the distance between the electric machine 102 and the power rails 118 would be closer to the ideal and/or baseline distance. In some cases, extra procedures may be needed to reconnect the current collector 126 of the arm 120 with the power rails 118 of the power system 114.

In some cases, the display 400 may show one or more arrows 420 that indicate a direction that the operator of the electric machine 102 ought to steer the electric machine 102 to improve the alignment between the arm 120 and the power rails 118. For example, the arrow 420 may point left to indicate that the operator should steer the electric machine 102 to the left to improve the alignment between the arm 120 and the power rails 118. Similarly, the arrow 420 may point right to indicate that the operator should steer the electric machine 102 to the right to improve the alignment between the arm 120 and the power rails 118. In some cases, the size of the arrow 420, as displayed, may be modulated to indicate a magnitude by which the electric machine 102 should be steered to the left or the right. For example, a relatively larger arrow 420 may indicate the need for a relatively larger move to the left or the right, while a relatively smaller arrow 420 may indicate the need for a relatively smaller move to the left or the right.

It should be understood that the indicators 302, 404 are merely example indicators to indicate misalignment, as determined by rotational sensor 216 data by the controller 112, to an operator of the electric machine 102. It should be understood that there may be any variety of other ways contemplated in this disclosure for indicating a level of misalignment of the arm 120 to the power rails 118 to the operator of the electric machine 102. For example, other displays indicating misalignment, deflection, and/or excursions from a baseline distance may be displayed on a heads up display, a helmet display, on smart glasses, on a projected display on a windshield of the electric machine 102 or the like. Other ways to indicate the misalignment, deflection, and/or excursions from a baseline distance may use audio, such as by playing audio such as “SLIGHT LEFT,” “MODERATELY RIGHT,” “HARD RIGHT,” or the like. In yet other cases, tactile, vibrational, and/or haptic devices may be used to indicate to an operator steering directions to guide the electric machine 102 to better alignment with the power system 114. For example, haptic devices may be integrated into a steering wheel or seat on which the operator sits within the operator station 106. Directional vibrational pulses may be used to guide the operator to better alignment between the electric machine 102 and the power rails 118.

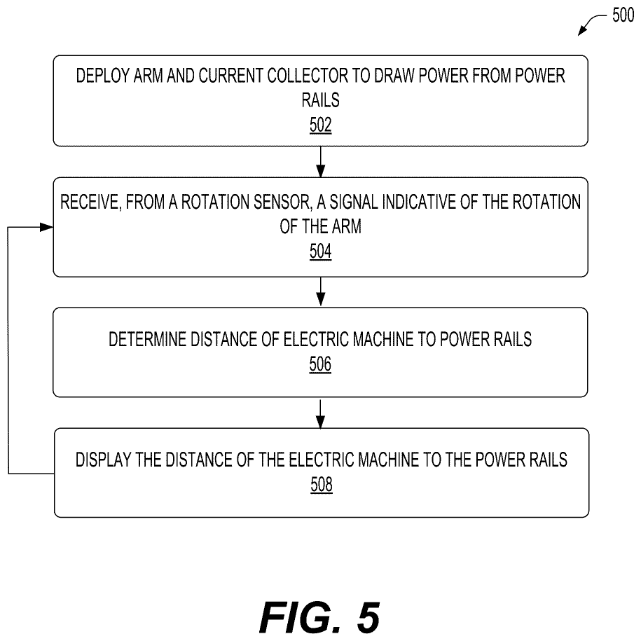

FIG. 5 is a flow diagram depicting an example method 500 for indicating an alignment of the electric machine 102 with the power rails 118 of the power system 114 that delivers power to the electric machine 102, according to examples of the disclosure. The processes of method 500 may be performed by the controller 112, individually or in conjunction with other components of the electric machine 102. Method 500 allows the controller 112 and the electric machine 102 to identify the magnitude of misalignment between the power collecting apparatus of the electric machine 102, as the arm 120, and the current carrying apparatus of the power system 114, as the power rails 118. Thus, method 500 provides an indication, to an operator, of the magnitude of an angle of deflection of the arm 120 from an optimal and/or baseline angle. It should be understood that the optimal and/or baseline angle may correspond to an optimal and/or baseline distance between the electric machine 102 and the power rails 118.

At block 502, the controller 112 may cause the arm 120 and the current collector 126 to deploy to draw power from the power rails 118. In some cases, when the electric machine 102 approaches the power system 114 at a worksite, the electric machine 102 may deploy, or extend out the boom 122 and the arm 120 to make contact between the current collector 126 and the power rails 118. In other words, the electric machine 102 is configured to deploy the arm 120 from a stowed position. When the arm 120 is deployed and electric power is being collected from the power system 114, there may be indicators or other HMIs that indicate that power is being drawn, by the electric machine 102, from the power system 114. The use of the arm 120 and boom 122 based power draw may prompt the rest of the processes of method 500 to display the level of alignment of the arm 120 relative to the power rail 118, as compared to a baseline angle. Alternatively or additionally, the use of the arm 120 and boom 122 based power draw may prompt the rest of the processes of method 500 to display the distance between the electric machine 102 and the power rail 118, as compared to a baseline angle.

At block 504, the controller 112 may receive a signal, from the rotation sensor 216. The signal from the rotation sensor 216 may be indicative of the amount (e.g., angle) of rotation of the rotating joint 130. The controller 112 may use the signal from the rotation sensor 216 to determine how much the rotating joint 130 is rotated relative to a baseline level of rotation. The controller 112 may receive the rotation sensor 216 signal via any suitable wired or wireless channel. The rotation sensor 216 may encode the level of rotation at the rotating joint using any suitable scale, voltage bounds, modulation schemes, etc., and the controller 112 is configured to decode the signal from the rotation sensor 216.

At block 506, the controller 112 may determine a distance between the electric machine 102 and the power rails 118. The amount of rotation at the rotating joint 130 may correlate to the distance between the electric machine 102 and the power rails 118. Therefore, the controller 112 is able to determine the distance from the electric machine 102 to the power rails 118. In some cases, the controller 112 may be able to determine if the distance between the electric machine 102 and the power rails 118 is greater than a baseline distance. The baseline distance, in some cases, may represent an ideal or near ideal distance between the electric machine 102 and the power rails 118. The controller 112 may use a mathematical function, a look-up table, or any other suitable mapping between the rotation sensor 216 signal and the distance between the electric machine 102 and the power rails 118, or any excursion from a baseline distance thereof.

From the rotation sensor 216 signal, the controller 112 may also determine the current level of misalignment of the arm 120 with the power rails 118. This information may be determined based on the magnitude of rotation of the rotating joint 130, as measured by the rotation sensor 216. The controller 112 may further determine how much the distance between the electric machine 102 and the power rails 118 deviates from an ideal and/or baseline distance. The baseline distance, in this case, may represent a perfect or near perfect alignment of the arm 120 with the power rails 118.

It will be appreciated that the controller 112 may be configured to determine and/or report a variety of factors based at least in part on the rotation sensor signal, all of which correlate to or indicate the alignment of the arm 120 with the power rails 118. The controller 112, in some cases, may simply determine the amount of rotation, such as in degrees or radians, of the rotating joint 130 and report the same. In other cases, the controller 112 may determine the excursion of the rotation of the rotating joint 130 from a baseline or ideal level and report the same. In still other cases, the controller 112 may determine the magnitude of the angle between the arm 120 and the power rails 118 and report the same. In yet other cases, the controller 112 may determine the excursion of the angle between the arm 120 and the power rails 118 from a baseline or ideal level and report the same. In further cases, the controller 112 may determine the distance between the electric machine 102 and the power rails 118 and report the same. In further cases yet, the controller 112 may determine an excursion of the distance between the electric machine 102 and the power rails 118 from a baseline or ideal level and report the same.

At block 508, the controller 112 may display the distance between the electric machine 102 and the power rails 118. The distance between the electric machine 102 and the power rail 118 or any other measure of alignment between the electric machine 102 and the power rails 118 may be displayed on the indicators 302, 404 or similar displays or other HMIs. In some cases, the excursion of the distance from a baseline and/or ideal distance may be displayed, such as on the indicators 302, 404, or the like. The displays may also indicate to the operator which way to steer to improve the alignment of the electric machine 102 to the power system 114. In some cases, the controller 112 may be configured to disconnect the current collector 126 from the power rails 118, electrically and/or physically, if there is a relatively high likelihood of the current collector 126 becoming unseated from the power rails 118. The method 500 may return to block 502 to continue to receive signals from the rotation sensor 216 and generate an indication of the alignment of the electric machine 102 with the power rails 118.

It should be noted that some of the operations of method 500 may be performed out of the order presented, with additional elements, and/or without some elements. Some of the operations of method 500 may further take place substantially concurrently and, therefore, may conclude in an order different from the order of operations shown above.

It should be understood that the method 500 improves the ability of operators of electric machines 102 to maintain good alignment with the power system 114, allowing for more reliable and robust draw of power, by the electric machine 102 and from the power rails 118. Thus, the operator does not have to separately and visually monitor the arm 120, the current collector 126, or the power rails 118 to maintain a reliable connection between the current collector 126 and the power rails 118. Instead, the systems and methods, as disclosed herein, can assist the operator in maintaining robust transfer of power from the power system 114 to the electric machine 102 without distraction.

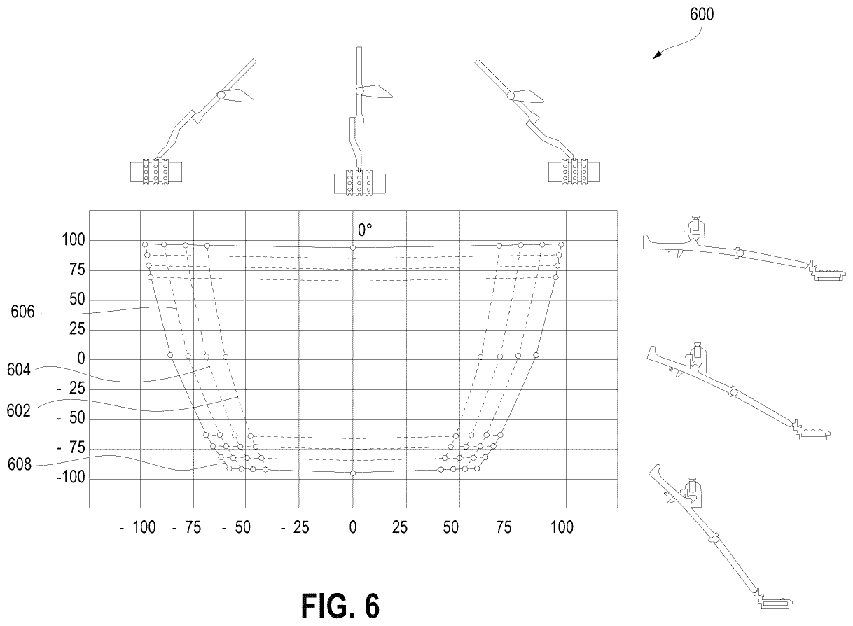

FIG. 6 is a chart 600 of a range of angles of misalignment accommodated by the arm 120 of the electric machine 102 during operation, according to examples of the disclosure. The axes of the chart 600 may represent a percentage of a maximum the angular deflection from a baseline angle of the rotating joint 130 and/or the angular deflection from a baseline angle between the arm 120 and the power rails 118. The percent of maximum deflection in the vertical (z-axis) direction is represented on the y-axis of chart 600, while the percent of maximum deflection in the horizontal direction (y-axis) may be shown on the x-axis of chart 600. As shown the baseline and/or ideal angle is represented as 0° and 0%, with angular deflections therefrom. It will be appreciated that the angular deflection, as depicted on chart 600, may be shown in other ways, such as an angular value in degrees or radians, or any suitable scaling thereof..

Boundary 602 may represent a level of deflection that is easily tolerable by the arm 120 and boom 122, with little risk of disconnection of the current collector 126 from the power rails 118. The deflection levels represented by boundary 602 may correlate to the green lights 304, 306, 308, 406 of indicators 302, 404. Boundary 604 may represent a level of deflection that is fairly tolerable by the arm 120 and boom 122, with small risk of disconnection of the current collector 126 from the power rails 118. The deflection levels represented by boundary 604 may correlate to the yellow lights 310, 312, 408, 410 of indicators 302, 404. Boundary 606 may represent a level of deflection that is poorly tolerable by the arm 120 and boom 122, with some risk of disconnection of the current collector 126 from the power rails 118. The deflection levels represented by boundary 606 may correlate to the orange lights 314, 316, 412, 414 of indicators 302, 404. Boundary 608 may represent a level of deflection, beyond which is not tolerable to maintain electrical connection between the electric machine 102 and the power rails 118. The deflection levels represented by boundary 608 may correlate to the red lights 318, 320, 416, 418 of indicators 302, 404. In some cases, the arm 120 and the boom 122 may be retracted when the current collector 126 is at a relatively high risk of being unseated from the power rails 118.

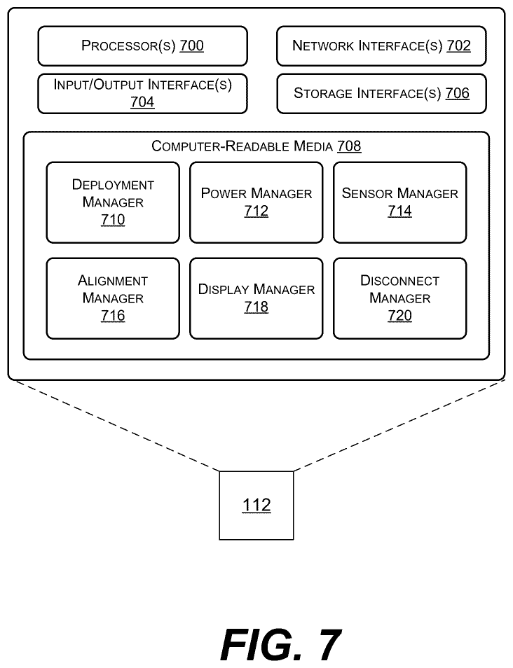

FIG. 7 is a block diagram of the controller 112 that may assist in alignment of the electric machine 102 with the power system 114, according to examples of the disclosure. The controller 112 includes one or more processor(s) 700, one or more network interface(s) 702, one or more input/output (I/O) interface(s) 704, one or more storage interface(s) 706, and computer-readable media 708. In examples, the processor(s) 700, network interface(s) 702, I/O interfaces 704, storage interface(s) 706, and/or computer-readable memory 708 may be part of an electronic device, such as an electric machine control device.

In some implementations, the processors(s) 700 may include a central processing unit (CPU), a graphics processing unit (GPU), both CPU and GPU, a microprocessor, a digital signal processor or other processing units or components known in the art. Alternatively, or in addition, the functionality described herein can be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) 700 may possess its own local memory, which also may store program modules, program data, and/or one or more operating systems. The one or more processor(s) 700 may include one or more cores.

The network interface(s) 702 may enable the controller 112 to communicate via the one or more network(s). The network interface(s) 702 may include a combination of hardware, software, and/or firmware and may include software drivers for enabling any variety of protocol-based communications, and any variety of wireline and/or wireless ports/antennas. For example, the network interface(s) 702 may include one or more of WiFi, cellular radio, a wireless (e.g., IEEE 802.1x-based) interface, a Bluetooth® interface, and the like. In some cases, if a remote control is used to control the electric machine 102, one or more operator signals may be sent and/or received by the controller 112.

The one or more input/output (I/O) interface(s) 704 may enable the controller 112 to detect interaction with a human operator. For example, the operator may provide task instructions to be executed by electric machines 102 at the worksite. Thus, the I/O interface(s) 704 may include and/or enable the controller 112 to receive indications of what actions the electric machine 102 is to perform.

The storage interface(s) 706 may enable the processor(s) 700 to interface and exchange data with the computer-readable medium 708, as well as any storage device(s) external to the controller 112. The storage interface(s) 706 may further enable access to removable media.

The computer-readable media 708 may include volatile and/or nonvolatile memory, removable and non-removable media implemented in any method or technology for storage of information, such as computer-readable instructions, data structures, program modules, or other data. Such memory includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, RAID storage systems, or any other medium which can be used to store the desired information and which can be accessed by a computing device. The computer-readable media 708 may be implemented as computer-readable storage media (CRSM), which may be any available physical media accessible by the processor(s) 700 to execute instructions stored on the memory 708. In one basic implementation, CRSM may include random access memory (RAM) and Flash memory. In other implementations, CRSM may include, but is not limited to, read-only memory (ROM), electrically erasable programmable read-only memory (EEPROM), or any other tangible medium which can be used to store the desired information, and which can be accessed by the processor(s) 700. The computer-readable media 708 may have an operating system (OS) and/or a variety of suitable applications stored thereon. The OS, when executed by the processor(s) 700 may enable management of hardware and/or software resources of the controller 112.

Several components such as instruction, data stores, and so forth may be stored within the computer-readable media 708 and configured to execute on the processor(s) 700. The computer readable media 708 may have stored thereon a deployment manager 710, a power manager 712, a sensor manager 714, an alignment manager 716, a display manager 718, and a disconnect manager 720. It will be appreciated that each of the components 710, 712, 714, 716, 718, 720 may have instructions stored thereon that when executed by the processor(s) 700 may enable various functions pertaining to operating the electric machine 102, as described herein.

The instructions stored in the deployment manager 710, when executed by the processor(s) 700, may configure the controller 112 to deploy the boom 122 and/or the arm 120 to collect power from the power system 114 and the power rails 118. The deployment of the boom 122 and/or the arm 120 may be initiated by operator input to cause the deployment. In some cases, only portions of a worksite may have the power system 114 deployed, and therefore, power may be collected by the electric machine 102 from the power system 114 only when near power rails 118.

The instructions stored in the power manager 712, when executed by the processor(s) 700, may configure the controller 112 to receive power from the power system 114 and its power rails 118. The controller 112 may coordinate, individually or in cooperation with other controllers, using the received power for performing tasks and/or for recharging on-board batteries.

The instructions stored in the sensor manager 714, when executed by the processor(s) 700, may configure the controller 112 to receive signals from the rotation sensor 216 indicative of the level of rotation of the rotating joint 130. The signal from the rotation sensor 216 may come in over time as a time series signal. The signal may be analog, digital, or any other suitable signal with any suitable encoding and/or modulation scheme.

The instructions stored in the alignment manager 716, when executed by the processor(s) 700, may configure the controller 112 to use the received rotation sensor signals to determine any variety of metric to display to operator of the electric machine 102. Some of these metrics may be the rotation of the rotating joint 130, the angle between the arm 120 and the power rails 118, the distance between the electric machine 102 and the power rails 118, or the deviation of any of the aforementioned from a baseline and/or ideal level.

The instructions stored in the display manager 718, when executed by the processor(s) 700, may configure the controller 112 to display, such as to an operator of the electric machine 102, the level of alignment of the electric machine 102 to the power system 114. As disclosed herein, the controller may display the alignment on indicator 302, 404, or any other suitable visual, audible, and/or haptic way.

The instructions stored in the disconnect manager 720, when executed by the processor(s) 700, may configure the controller 112 to disconnect the current collector 126 from the power rails 118, if the risk of disconnection or shorting is beyond a threshold acceptable level. The disconnection may be electrical, where a switch disconnects any power draw by the electric machine 102. The disconnection may also be physical, where the controller 112 causes the boom 122 and/or arm 120 to retract from a deployed position. The automatic disconnection may be used to prevent shorting and/or damaging the power system 114 and or electric machine 102.

### INDUSTRIAL APPLICABILITY

The present disclosure describes systems and methods for providing a low-distraction mechanism to allow an operator of the electric machine 102 to maintain good alignment between the electric machine 102 and the power system 114 to ensure robust availability of electric power for the electric machine 102. Electric machines 102 have on-board batteries that traditionally need to be charged, such as at a stationary charging station. The charging of large batteries for large construction or farming equipment may take a relatively long time, particularly compared to refueling traditional diesel or gasoline powered machines. As a result, it is desirable to implement the rail-based power system 114, where the electric machine 102 can dynamically draw power for its own operations and further to charge its on-board batteries while in use. The power system 114, therefore, mitigates the need for charging downtime related to electrical machines 102, resulting in greater deployment of machinery. This results in improved financial metrics related to capital expenditures, such as greater ROI and ROC, as well as greater productivity form worksite 100 assets.

In addition to worksite efficiencies, the electric machine 102 and the power system 114 introduces additional advantages with respect to the electric machines 102 themselves. Because the electric machines 102 can draw power while engaging in productive tasks, the on-board batteries of the electric machines 102 can be right-sized to smaller sizes. By having reduced size of the on-board batteries, the electric machines 102 of this configuration have an additional advantage of reduced cost and weight and increased reliability compared to traditional electric machines.

The use of the power system 114 by the electric machine 102, however, may introduce reliability issues. For example, if the electric machine 102 is not properly spaced within an acceptable range of distance from the power rails 118, the electric machine 102 may become electrically disconnected from the power system 114 and/or even short or damage the power system 114 and/or the electric machine 102. By providing a guidance system to properly align the electric machine 102 to the power system 114, an operator can more effectively and robustly maintain power flow between the powersystem 114 and the electric machine 102 without undue distraction.

Although the systems and methods of electric machines 102 are discussed in the context of a mining truck and other mining machinery, it should be appreciated that the systems and methods discussed herein may be applied to a wide array of machines and vehicles across a wide variety of industries, such as construction, mining, farming, transportation, military, combinations thereof, or the like. For example, the alignment mechanism disclosed herein may be applied to a compactor in the paving industry or a harvester in the farming industry.

While aspects of the present disclosure have been particularly shown and described with reference to the examples above, it will be understood by those skilled in the art that various additional examples may be contemplated by the modification of the disclosed machines, systems and methods without departing from the spirit and scope of what is disclosed. Such examples should be understood to fall within the scope of the present disclosure as determined based upon the claims and any equivalents thereof.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein.

What is claimed is:

1. An alignment guidance system, comprising:
a rotation sensor associated with a power collecting arm of an electric machine, the power collecting arm configured to collect power from a power rail;
a controller including one or more processors;
an indicator; and
one or more computer-readable media storing computer-executable instructions that, when executed by the one or more processors, cause the controller to:
receive a signal from the rotation sensor, the signal indicative of a level of rotation of the power collecting arm;
determine, based at least in part on the signal, a first distance between the electric machine and the power rail; and
display, on the indicator, an indication of the first distance between the electric machine and the power rail.

2. The alignment guidance system of claim 1, wherein the computer-executable instructions, when executed by the one or more processors, further cause the controller to:
determine a deviation of the first distance from a baseline distance between the electric machine and the power rail, wherein the indicator is configured to indicate the deviation.

3. The alignment guidance system of claim 2, wherein the indicator includes one or more lights to indicate a magnitude of the deviation of the first distance from the baseline distance.

4. The alignment guidance system of claim 2, wherein the computer-executable instructions, when executed by the one or more processors, further cause the controller to:
indicate, on the indicator, a direction of the deviation of the first distance from the baseline distance.

5. The alignment guidance system of claim 2, wherein the computer-executable instructions, when executed by the one or more processors, further cause the controller to:
determine a direction to steer the electric machine to reduce the deviation; and
indicate, on the indicator, the direction.

6. The alignment guidance system of claim 1, further comprising:
a camera configured to generate an image of a path to be traversed by the electric machine, wherein the computer-executable instructions, when executed by the one or more processors, further cause the controller to:
display, on the indicator, the image.

7. The alignment guidance system of claim 1, further comprising:
a rotating joint, wherein the signal from the rotation sensor indicates a magnitude of rotation of the rotating joint.

8. The alignment guidance system of claim 1, wherein the power collecting arm includes a current collector seated on the power rail and the first distance between the electric machine and the power rail corresponds to a risk of the current collector being unseated from the power rail.

9. The alignment guidance system of claim 1, wherein the computer-executable instructions, when executed by the one or more processors, further cause the controller to:
receive a second signal from the rotation sensor, the second signal indicative of a second level of rotation of the power collecting arm at a second time after when the signal was received from the rotation sensor;
determine, based at least in part on the second signal, a second distance between the electric machine and the power rail; and
display, on the indicator, a second indication of the second distance between the electric machine and the power rail.

10. A method, comprising:
receiving, by a controller comprising one or more processors, a signal from a rotation sensor associated with an arm of an electric machine for collecting current from a power rail, the signal indicative of a level of rotation of the arm;
determining, based at least in part on the signal, an angle of rotation of the arm;
displaying, on an indicator using one or more lights, an indication of the angle of rotation of the arm; and
displaying, on the indicator, a direction that the electric machine is to be steered to reduce the rotation of the arm from a baseline rotation angle.

11. The method of claim 10, further comprising:
illuminating, by the controller, one or more lights of the indicator to indicate the angle of rotation of the arm.

12. The method of claim 10, further comprising:
receiving, from a camera and by the controller, one or more images of a path being traversed by the electric machine; and
displaying the one or more images on the indicator along with the indication of the angle of rotation of the arm.

13. The method of claim 10, further comprising:
determining, based at least in part on the signal, a distance between the electric machine and the power rail; and
displaying, on the indicator, an indication of the distance between the electric machine and the power rail.

14. The method of claim 13, further comprising:
determining, by the controller, a deviation of the distance from a baseline distance between the electric machine and the power rail, wherein the indicator is configured to indicate the deviation.

15. An electric machine, comprising:
a power collecting arm to collect power from a power rail;
a rotation sensor associated with the power collecting arm;
an indicator; and
a controller configured to:
receive a signal from the rotation sensor, the signal indicative of a level of rotation of the power collecting arm;
determine, based at least in part on the signal, an angle of rotation of the power collecting arm; and
display, on the indicator using one or more lights, an indication of the angle of rotation of the power collecting arm.

16. The electric machine of claim 15, further comprising:
a camera configured to generate an image of a path to be traversed by the electric machine, wherein the controller is further configured to:
display, on the indicator, the image.

17. The electric machine of claim 15, wherein the controller is further configured to:
display, on the indicator, a direction that the electric machine is to be steered to reduce the rotation of the power collecting arm from a baseline rotation angle.

18. The electric machine of claim 15, wherein the controller is further configured to:
determine, based at least in part on the signal, a first distance between the electric machine and the power rail; and
determine a deviation of the first distance from a baseline distance between the electric machine and the power rail.

19. The electric machine of claim 18, wherein the controller is further configured to:
determine a direction to steer the electric machine to reduce the deviation; and
indicate, on the indicator, the direction.

20. The electric machine of claim 18, wherein the power collecting arm includes a current collector seated on the power rail and the deviation corresponds to a risk of the current collector being unseated from the power rail.
